(19) United States
(12) Patent Application Publication
(10) Pub. No.: US 2006/0290206 A1
(43) Pub. Date: Dec. 28, 2006

(54) Fan power supply apparatus and image projection apparatus

(76) Inventor: Kunihiko Tabei, Kawachi-gun (JP)

Correspondence Address: MORGAN & FINNEGAN, L.L.P., 3 WORLD FINANCIAL CENTER, NEW YORK, NY, 10281-2101, US

(21) Appl. No.: 11/476,235

(22) Filed: Jun. 27, 2006

(30) Foreign Application Priority Data
Jun. 27, 2005 (JP) 2005-187023

(51) Int. Cl. H02J 9/00

(52) U.S. Cl. 307/66

(57) ABSTRACT

A fan power supply apparatus is disclosed, which is capable of cooling a lamp to an adequate temperature in a case where AC power is shut off. The fan power supply apparatus comprises a DC generator which generates DC power from AC power, a backup power supply which is charged with the DC power from the DC generator,a supplying device which supplies the DC power from the backup power supply to the cooling fan. The controller controls the supplying device to start supplying the DC power to the cooling fan when the input of the AC power is stopped and controls the supplying device to stop supplying the DC power in response to the elapse of a predetermined time period detected with a timer after the start of the DC power supply.

### BACKGROUND OF THE INVENTION

The present invention relates to fan power supply apparatus which supplies electric power to a cooling fan that cools a projection lamp.

Image projection apparatuses, such as liquid crystal projectors and overhead projectors, project light from an original image illuminated with light from a light-emitting lamp as a light source through a projection lens. The projection lamp is a pyrogenetic device, and its temperature increases for a while after the light emission is stopped. Therefore it is necessary to cool the lamp with a cooling fan to a predetermined temperature after a lamp switch or a power switch of the image projection apparatus is turned off.

In the conventional image projection apparatus, the cooling fan is operated for a predetermined time measured by a timer or the like. The driving power of the cooling fan in that apparatus is obtained by converting AC power from the commercial power supply into DC power.

However, the power from the commercial power supply which is necessary for driving the cooling fan cannot be shut off, in other words, the apparatus cannot be unplugged until the cooling is finished even when a user wants to move the apparatus immediately after image projection. This is inconvenient for the user.

To solve this inconvenience, a technique has been proposed in Japanese Patent Laid-Open No. H09(1997)-151896. In this technique, a backup power supply with a large electric capacity such as an electric double layer capacitor, charged with electric power, enables the cooling fan to continue operating.

FIG. 6 shows the configuration of the power supply circuit proposed in Japanese Patent Laid-Open No. H09(1997)-151896. When a main power switch 15 is turned on, AC power is supplied to a DC power supply 16 from the commercial power supply through a power plug 14. The DC power supply 16 converts the AC power into DC power to supply it to a cooling fan (motor) 19 through a diode 17. Thereby, the cooling fan 19 is driven and an electric double layer capacitor 18 is charged.

When the power plug 14 is unplugged, the energy accumulated in the electric double layer capacitor 18 acts as a backup power supply to drive the cooling fan 19 to continue cooling until the energy is exhausted.

However, in the art proposed in Japanese Patent Laid-Open No. H09(1997)-151896, the cooling fan 19 is driven until the energy accumulated in the capacitor is exhausted. Cooling the lamp as long as possible is not always good for the lamp; the overcooling might cause the shortening of the operating life of the lamp.

In addition, since the cooling fan can be driven with a voltage less than its rated voltage, it is uncertain how much cooling is achieved finally when the energy of the capacitor is exhausted.

Furthermore, in a case where the power plug is unplugged while the cooling fan is driven with the commercial power supply and a timer, the lamp is overcooled since the cooling fan starts its operation with the capacitor from that point and continues cooling for a longer period than the time expected.

### BRIEF SUMMARY OF THE INVENTION

One object of the present invention is to provide a fan power supply apparatus and an image projection apparatus, which are capable of cooling the lamp to an adequate temperature in a case where the AC power plug is unplugged or the like.

According to an aspect, the present invention provides a fan power supply apparatus which supplies DC power to a cooling fan that cools a projection lamp. The fan power supply apparatus comprises a DC generator which generates DC power from AC power, a backup power supply which is charged with the DC power from the DC generator, a supplying device which supplies the DC power from the backup power supply to the cooling fan, and a controller which controls the supplying unit. The controller controls the supplying device to start supplying the DC power from the backup power supply to the cooling fan when the input of the AC power is stopped and controls the supplying device to stop supplying the DC power after a predetermined time elapse detected with a timer after the start of the DC power supply.

According to another aspect, the present invention provides a fan power supply apparatus which supplies DC power to a cooling fan that cools a projection lamp. The fan power supply apparatus comprises a DC generator which generates DC power from AC power, a backup power supply which is charged with the DC power from the DC generator, a supplying device which supplies the DC power from the backup power supply to the cooling fan, a controller which controls the supplying unit, and a detector which detects temperature of one of the projection lamp and a portion heated by heat from the projection lamp. The controller controls the supplying device to start supplying the DC power from the backup power supply to the cooling fan when the input of the AC power is stopped and controls the supplying device to stop supplying the DC power power according to reduction of the temperature detected by the detector to a predetermined temperature after the start of the DC power supply.

According to still another aspect, the present invention provides an image projection apparatus which drives a cooling fan that cools a light source lamp (projection lamp) with any one of the above-mentioned fan power supply apparatuses.

Other objects and features of the present invention will become readily apparent from the following description of the preferred embodiments with reference to accompanying drawings.

### BRIEF DESCRIPTION OF THE DRAWINGS

FIG. 1 is a block diagram showing the configuration of the power supply unit that is Embodiment 1 of the present invention.

FIG. 2 is a flowchart showing the operation of the power supply unit in Embodiment 1.

FIG. 3 is a block diagram showing the configuration of the power supply unit that is Embodiment 2 of the present invention.

FIG. 4 is a flowchart showing the operation of the power supply unit in Embodiment 2.

FIG. 5 is the projector that is an embodiment of the present invention.

FIG. 6 is a block diagram showing the configuration of a conventional power supply unit.

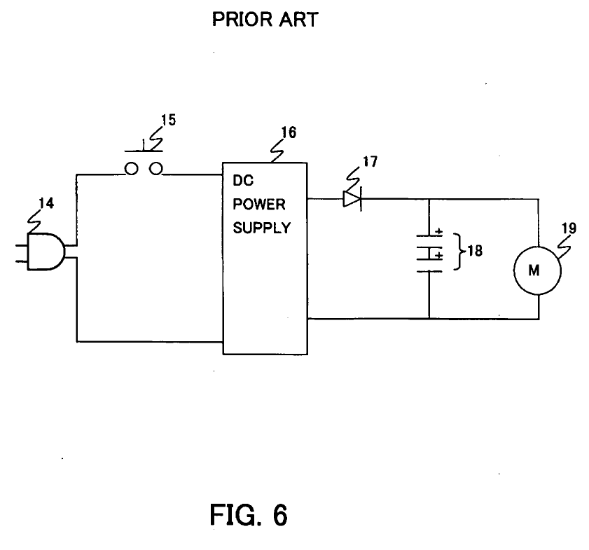

### DETAILED DESCRIPTION OF THE PREFERRED EMBODIMENTS

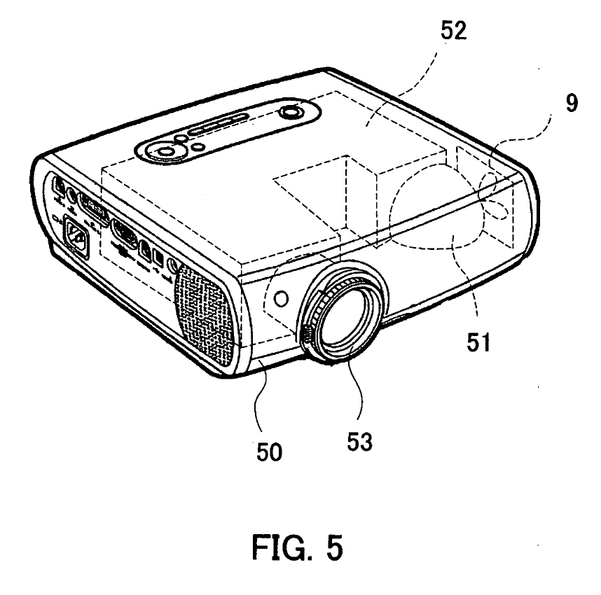

Preferred embodiments of the present invention will hereinafter be described with reference to the drawings. Embodiment 1 FIG. 5 shows the general configuration of the liquid crystal projector (image projection apparatus) that is Embodiment 1 of the present invention.

In FIG. 5, 50 denotes a chassis of the liquid crystal projector, 51 a projection lamp housed in the chassis 50. A high-intensity lamp such as an extra high pressure mercury lamp is used as the lamp 51. 52 denotes a projection optical unit which is housed in the chassis 50. The projection optical unit 52 separates white light from the lamp 51 into R, G and B light components to lead them to liquid crystal panels for R, G and B, not shown, and combines the G and B light components from the liquid crystal panels to lead a projection lens 53. 9 denotes an electrically-driven cooling fan which generates cooling air flow to cool the lamp 51.

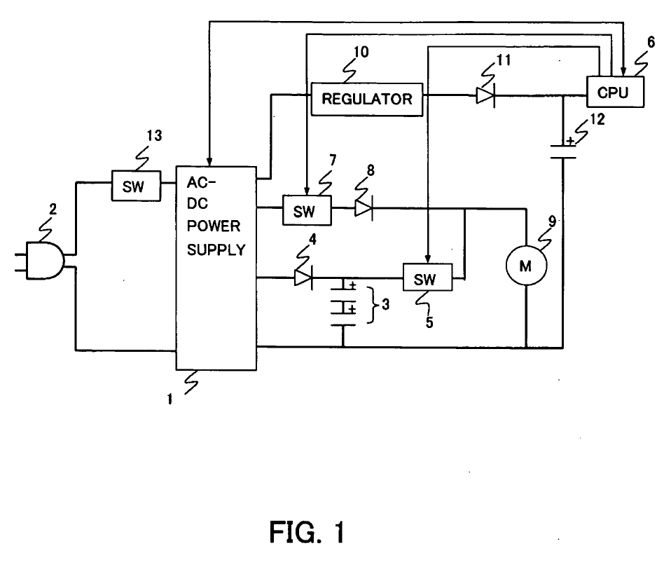

FIG. 1 shows the configuration of the power supply unit (power supply apparatus) which supplies DC power that is driving power to the cooling fan (fan motor) 9.

1 denotes an AC-DC power supply which generates DC (direct current) power for plural systems in the projector from a commercial power supply (100 volts or 120 volts for home use, for example). A part of the DC power is supplied to electric circuits in the projector, which include a CPU 6, other than the cooling fan 9.

2 denotes an AC (alternate current) plug which is connected to the AC-DC power supply 1 and plugged into an outlet of the commercial power supply.

3 denotes a first electric double layer capacitor which is used as a backup power supply. The first electric double layer capacitor 3 is charged with DC power that is an output for a charging system from the AC-DC power supply 1. 4 denotes a diode which prevents reverse flow of the discharged DC output from the first electric double layer capacitor 3 to the AC-DC power supply 1.

5 denotes a discharging switch used as a supplying device, which switches the first electric double layer capacitor 3 between a charging state and a discharging state. When the AC plug 2 is plugged into the outlet and the discharging switch 5 is set to the charge position (OFF), the first electric double layer capacitor 3 is charged with the DC power from the AC-DC power supply 1. When the discharging switch 5 is operated to the discharge position (ON), the DC power that is the discharged output from the first electric double layer capacitor 3 is supplied to the cooling fan 9. The switching operation of the discharging switch 5 is controlled by the CPU 6 as a controller. The CPU 6 controls not only this power supply unit but also the whole of the projector.

7 denotes a fan switch that is connected to a cooling system output part of the AC-DC power supply 1, which is different from a charging system output part thereof. When the fan switch 7 is operated to the drive position (ON), the DC current that is an output for a fan driving system is supplied to the cooling fan 9 through a diode 8. The switching operation of the fan switch 7 is also controlled by the CPU 6.

The cooling fan 9 (fan motor) is driven with DC power. The cooling fan 9 can be driven with the DC power from the fully charged first electric double layer capacitor 3 for a few minutes.

10 denotes a regulator which is connected to a controlling system output part of the AC-DC power supply 1 and supplies stable DC power to the CPU 6 through a diode 11. The diode 11 prevents reverse flow of the direct current to the regulator 10.

12 denotes a second electric double layer capacitor which is connected to a part between the diode 11 and the CPU 6. The fully charged second electric double layer capacitor 12 can drive the CPU 6 for many hours.

13 denotes a main switch which is operated by an user to switch the AC power from the commercial power supply on and off.

In the power supply unit constituted as above, when the AC plug 2 is plugged into the outlet of the commercial power supply, not shown, and the main switch 13 is operated to the operation position (ON), the AC-DC power supply 1 outputs the DC power to each system.

As described above, the output for the controlling system is supplied to the CPU 6 through the regulator 10 and the diode 11 to start the CPU 6. The output for the charging system charges the second electric double layer capacitor 12 which is connected to the part between the diode 11 and the CPU 6. After starting, the CPU 6 causes the lamp 51 that is a heating device to light. At the same time, the CPU 6 turns the fan switch 7 ON, and thereby the output for the cooling system is supplied to the cooling fan 9 to drive it. The output for the charging system charges the first electric double layer capacitor 3 through the diode 4.

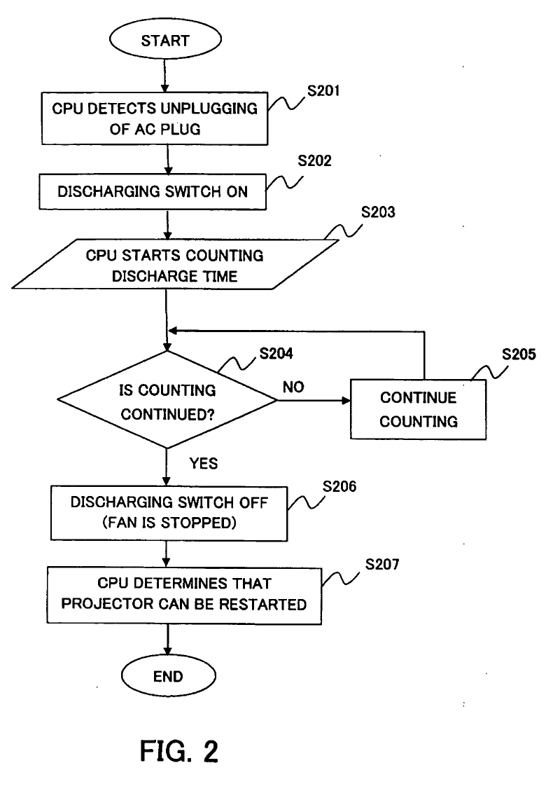

After the start of the projector as above, when the input of the AC power to the power supply unit is shut off by unplugging of the AC plug 2 or a failure of the commercial power supply, the CPU 6 operates according to the flowchart shown in FIG. 2. The operation is executed according to a computer program stored in the CPU 6.

If the input of the AC power to the power supply unit is shut off by unplugging of the AC plug 2 or the like at Step (hereinafter, abbreviated as “S”)201, the CPU 6 detects it and then proceeds to S202. At S202, the CPU 6 turns the discharging switch 5 ON to cause the first electric double layer capacitor 3 to discharge. The discharged DC output power from the first electric double layer capacitor 3 is supplied to the cooling fan 9. Since the reverse flow preventing diodes 4 and 8 are provided, no reverse flow of the direct current from the first electric double layer capacitor 3 to the AC-DC power supply 1 occurs, and the entire discharged DC output power from the first electric double layer capacitor 3 is supplied to the cooling fan 9.

Thereby, it is possible to continue driving the cooling fan 9 even if the supply of the DC power from the AC-DC power supply 1 to the cooling fan 9 is shut off due to the stoppage of the input of the AC power to the power supply unit.

Next, at S203, the CPU 6 starts counting (measuring) a discharge time of the first electric double layer capacitor 3 from the start of the discharge.

Then, at S204, the CPU 6 determines whether or not the counted discharge time has reached a predetermined time. If the counted discharge time has not reached the predetermined time, the CPU 6 proceeds to S205 to continue discharging the first electric double layer capacitor 3 and counting the discharge time. The “predetermined time” is set arbitrarily based on the result of measurement of time taken to cool the lamp 51 with high temperature to a low temperature at which the lamp 51 is not overcooled, for example. The “predetermined time” is stored in a memory provided in the CPU 6.

Then, the CPU 6 repeats the determination at S204. If the counted discharge time has reached the predetermined time, the CPU 6 proceeds to S206 to turn the discharging switch 5 OFF. The drive of the cooling fan 9 thereby is stopped. This makes it possible to maintain an adequate lamp temperature at which the lamp 51 is not overcooled.

Next, the CPU 6 determines that the projector can be restarted at S207 and then finishes the operation in this flowchart.

As described above, since the CPU 6 controls the power supply unit so that the drive of the cooling fan 9 is stopped automatically according to elapse of the predetermined time before the energy accumulated in the first electric double layer capacitor 3 is exhausted, it is possible to prevent the lamp 51 from being overcooled.

In addition, the CPU 6, which operates with the DC power from the second electric double layer capacitor 12, controls so as not to light the lamp 51 when the user plugs the AC plug 2 into the outlet again and turns on the main switch 13 to force to restart the projector during execution of the process shown in FIG. 2. Thereby, it is possible to prevent degradation of the lamp 51 due to its relighting.

On the other hand, when the AC plug 2 is unplugged during the cooling operation with the commercial power supply, the CPU 6, which operates with the DC power from the second electric double layer capacitor 12, stores the cooling time up to that point and continues counting the time.

Then, the CPU 6 turns the discharging switch 5 ON to start driving the cooling fan 9 with the DC power from the first electric double layer capacitor 3. The CPU 6 adds the stored cooling time (that is, the cooling time during using the commercial power supply) to the cooling time during using the DC power from the first electric double layer capacitor 3, and stops the drive of the cooling fan 9 when the sum of the cooling times reaches the predetermined time. Thereby, it is possible to prevent degradation of the lamp 51 in the above case.

Embodiment 2

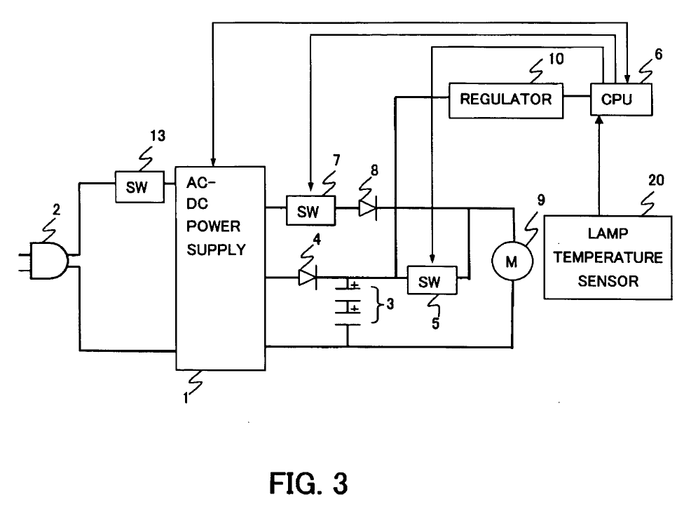

FIG. 3 shows the configuration of the power supply unit of the projector that is Embodiment 2 of the present invention. The configuration of the projector is the same as that in Embodiment 1. The same components as those in Embodiment 1 are designated with the same reference numerals as in Embodiment 1 and description thereof is omitted.

In this embodiment, the diode 11 and second electric double layer capacitor 12 used in Embodiment 1 are removed, and a lamp temperature sensor 20 is added. The lamp temperature sensor 20 may be a detector which detects the temperature of the lamp 51 itself and a detector which detects the temperature of a portion which is located at the periphery of the lamp 51 and heated by heat from the lamp 51.

As an operation condition in this embodiment, it is necessary that the charging voltage of the first electric double layer capacitor 3 is higher than the operating voltage of the CPU 6 and the charging capacity of the first electric double layer capacitor 3 is sufficient to drive the cooling fan 9 to the completion of the cooling.

When the AC plug 2 is plugged into the outlet of the commercial power supply and the main switch is turned to the operation position (ON), the AC-DC power supply 1 outputs the DC power to each system. The output for the controlling system is supplied to the CPU 6 through the diode 4 and the regulator 10 to start the CPU 6, and the output for the charging system is supplied to the first electric double layer capacitor 3 through the diode 4 to charge it.

After starting, the CPU 6 causes the lamp 51 that is a heating device to light. At the same time, the CPU 6 turns the fan switch 7 ON, and thereby the output for the cooling system is supplied to the cooling fan 9 to drive it.

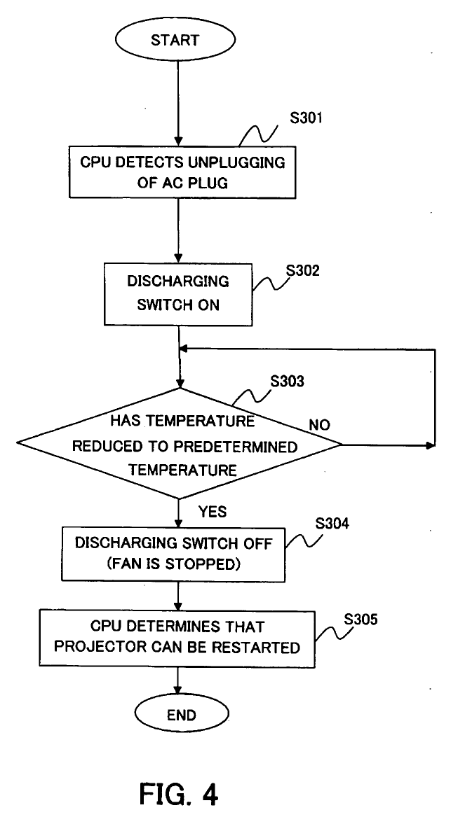

After starting the projector as above, when the input of the AC power to the power supply unit is shut off by unplugging of the AC plug 2 or a failure of the commercial power supply, the CPU 6 operates according to the flowchart shown in FIG. 4. The operation is executed according to a computer program stored in the CPU 6.

If the input of the AC power to the power supply unit is shut off by unplugging of the AC plug 2 or the like at S301, the CPU 6 detects it and then proceeds to S302. At S302, the CPU 6 turns the discharging switch 5 ON to cause the first electric double layer capacitor 3 to discharge. The discharged DC output power from the first electric double layer capacitor 3 is supplied to the cooling fan 9. Since the reverse flow preventing diodes 4 and 8 are provided, no reverse flow of the direct current from the first electric double layer capacitor 3 to the AC-DC power supply 1 occurs, and the entire discharged DC output power from the first electric double layer capacitor 3 is supplied to the cooling fan 9.

Thereby, it is possible to continue driving the cooling fan 9 even if the supply of the DC power from the AC-DC power supply 1 to the cooling fan 9 is shut off due to the stoppage of the input of the AC power to the power supply unit.

Next, at S303, the CPU 6 determines whether or not the temperature detected by the temperature sensor 20 has reduced to a predetermined temperature. If the detected temperature has not reduced to the predetermined temperature, the CPU 6 repeats the determination at S303. The “predetermined temperature” is set arbitrarily within a low temperature range in which the lamp 51 is not overcooled. The “predetermined temperature” is stored in a memory provided in the CPU 6.

On the other hand, if the detected temperature has reduced to the predetermined temperature at S303, the CPU 6 proceeds to S304 to turn the discharging switch 5 OFF. The drive of the cooling fan 9 thereby is stopped. This makes it possible to maintain an adequate lamp temperature at which the lamp 51 is not overcooled.

Next, the CPU 6 determines that the projector can be restarted at S305 and then finishes the operation in this flowchart.

As described above, since the CPU 6 controls the power supply unit so that the drive of the cooling fan 9 is stopped automatically before the lamp 51 is overcooled, it is possible to certainly prevent the lamp 51 from being overcooled.

According to each of the above-described embodiments, the cooling fan 9 can be driven by using the discharged output from the first electric double layer capacitor 3 when the input of the commercial AC power for some reason. Therefore, it is possible to certainly perform the cooling of the lamp 51 to its adequate temperature. In addition, since the drive of the cooling fan 9 is managed by the time or temperature which does not cause the overcooling of the lamp 51, it is also possible to certainly prevent the overcooling of the lamp 51.

Furthermore, the cooling fan can be driven to cool the lamp by using the electrical energy accumulated in the backup power supply when the input of the AC power is stopped by, for example, unplugging of the AC plug or a failure of the commercial power supply. In addition, the drive of the cooling fan is stopped automatically according to elapse of the predetermined time or reduction of the detected temperature to the predetermined temperature even if the electrical energy in the backup power supply still remains. Accordingly, it is possible to prevent reduction of the lamp life due to the overcooling.

As many apparently widely different embodiments of the present invention can be made without departing from the spirit and scope thereof, it is to be understood that the invention is not limited to the specific embodiments thereof except as defined in the appended claims.

For example, although a capacitor (an electric double layer capacitor) was used as the backup power supply in each of the above-described embodiments, a secondary battery capable of being charged with DC power can be used as the backup power supply. The circuit configuration including the secondary battery is similar to that shown in FIG. 1 or FIG. 3.

In addition, although the description was made of the power supply apparatus to drive the cooling fan for cooling the light source lamp used in the projector in each of the above-described embodiments, the present invention can be applied to a power supply apparatus to drive a cooling fan for cooling a lamp in other apparatuses such as copying machines.

Furthermore, the present invention is not limited to these preferred embodiments and various variations and modifications may be made without departing from the scope of the present invention.

This application claims foreign priority benefits based on Japanese Patent Application No. 2005-187023, filed on Jun. 27, 2005, which is hereby incorporated by reference herein in its entirety as if fully set forth herein.

What is claimed is:

1. A fan power supply apparatus which supplies DC power to a cooling fan that cools a projection lamp, the fan power supply apparatus comprising:
a DC generator which generates DC power from AC power;
a backup power supply which is charged with the DC power from the DC generator;
a supplying device which supplies the DC power from the backup power supply to the cooling fan; and
a controller which controls the supplying unit, wherein the controller controls the supplying device to start supplying the DC power from the backup power supply to the cooling fan when the input of the AC power is stopped and controls the supplying device to stop supplying the DC power in response to the elapse of a predetermined time period detected with a timer after the start of the DC power supply.

2. The fan power supply apparatus according to claim 1, wherein the backup power supply is a capacitor.

3. The fan power supply apparatus according to claim 1, wherein the backup power supply is a secondary battery.

4. The fan power supply apparatus according to claim 1, wherein the cooling fan cools the projection lamp used in an image projection apparatus which projects light from an image illuminated with light from the projection lamp.

5. An image projection apparatus comprising:
a projection lamp;
an image-forming element which forms an image and is illuminated with light from the projection lamp;
a projection lens which projects light from the image-forming element;
a cooling fan which cools the image-forming element; and
the fan power supply apparatus according to claim 4.

6. A fan power supply apparatus which supplies DC power to a cooling fan that cools a projection lamp, the fan power supply apparatus comprising:
a DC generator which generates DC power from AC power;
a backup power supply which is charged with the DC power from the DC generator;
a supplying device which supplies the DC power from the backup power supply to the cooling fan;
a controller which controls the supplying unit; and
a detector which detects temperature of the projection lamp or a portion heated by heat from the projection lamp,
wherein the controller controls the supplying device to start supplying the DC power from the backup power supply to the cooling fan when the input of the AC power is stopped and controls the supplying device to stop supplying the DC power in response to the detection of predetermined down of temperature by the detector after the start of the DC power supply.

7. The fan power supply apparatus according to claim 6, wherein the backup power supply is a capacitor.

8. The fan power supply apparatus according to claim 6, wherein the backup power supply is a secondary battery.

9. The fan power supply apparatus according to claim 6, wherein the cooling fan cools the projection lamp used in an image projection apparatus which projects light from an image illuminated with light from the projection lamp.

10. An image projection apparatus comprising:
a projection lamp;
an image-forming element which forms an image and is illuminated with light from the projection lamp;
a projection lens which projects light from the image-forming element;
a cooling fan which cools the image-forming element; and
the fan power supply apparatus according to claim 9.
